(19) United States
(12) Patent Application Publication
(10) Pub. No.: US 2025/0238407 A1
(43) Pub. Date: Jul. 24, 2025

(54) REPAIR STRINGS FOR A DEDUPLICATION STORAGE SYSTEM

(71) Applicant: HEWLETT PACKARD ENTERPRISE DEVELOPMENT LP, Spring, TX (US)

(72) Inventors: Joshua Peck, Bristol (GB); Alastair Slater, Chepstow (GB); Jack Smith, Bristol (GB)

(21) Appl. No.: 18/417,021

(22) Filed: Jan. 19, 2024

(51) Int. Cl. G06F 16/215

(52) U.S. Cl. CPC G06F 16/215

(57) ABSTRACT

Example implementations relate to deduplication operations in a storage system. An example includes selecting a comparison window in a first manifest of a deduplication storage system, where the comparison window comprises multiple data units and includes a corrupt string. The example also includes identifying multiple manifests, determining match scores for the manifests based on matching against the comparison window, and identifying multiple repair strings based on the match scores. The example also includes recording the corrupt string and the multiple repair strings in a first entry of a repair string data structure, and repairing the corrupt string in the first manifest using at least one of the multiple repair strings.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIG. 1 is a schematic diagram of an example storage system, in accordance with some implementations.

FIGS. 2A-2E are illustration of example data structures, in accordance with some implementations.

FIG. 3 is an illustration of an example process, in accordance with some implementations.

FIGS. 4A-4N are illustrations of example operations, in accordance with some implementations.

FIG. 5 is an illustration of an example process, in accordance with some implementations.

FIGS. 6A-6E are illustrations of example operations, in accordance with some implementations.

FIG. 7 is an illustration of an example process, in accordance with some implementations.

FIG. 8 is a diagram of an example machine-readable medium storing instructions in accordance with some implementations.

FIG. 9 is a schematic diagram of an example computing device, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may back up a collection of data (referred to herein as a “stream” of data or a “data stream”) in deduplicated form, thereby reducing the amount of storage space required to store the data stream. The storage system may create a “backup item” to represent a data stream in a deduplicated form. The storage system may perform a deduplication process including breaking a stream of data into discrete data units (or “chunks”) and determining “fingerprints” (described below) for these incoming data units. Further, the storage system may compare the fingerprints of incoming data units to fingerprints of stored data units, and may thereby determine which incoming data units are duplicates of previously stored data units (e.g., when the comparison indicates matching fingerprints). In the case of data units that are duplicates, the storage system may store references to previously stored data units instead of storing the duplicate incoming data units. A process for receiving and deduplicating an inbound data stream may be referred to herein as a “data ingest” process of a storage system.

As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof. A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a deduplication storage system may use metadata for processing inbound data streams (e.g., backup items). For example, such metadata may include data recipes (also referred to herein as “manifests”) that specify the order in which particular data units are received for each backup item. Further, such metadata may include item metadata to represent each received backup item in a deduplicated form. The item metadata may include identifiers for a set of manifests, and may indicate the sequential order of the set of manifests. The processing of each backup item may be referred to herein as a “backup process.” Subsequently, in response to a read request, the deduplication system may use the item metadata and the set of manifests to determine the received order of data units, and may thereby recreate the original data stream of the backup item. Accordingly, the set of manifests may be a representation of the original backup item. The manifests may include a sequence of records, with each record representing a particular set of data unit(s). The records of the manifest may include one or more fields that identify container indexes that index (e.g., include storage information for) the data units. For example, a container index may include one or more fields that specify location information (e.g., containers, offsets, etc.) for the stored data units, compression and/or encryption characteristics of the stored data units, and so forth. Further, the container index may include reference counts that indicate the number of manifests that reference each data unit.

In some examples, upon receiving a data unit (e.g., in a data stream), it may be matched against one or more container indexes to determine whether an identical chunk is already stored in a container of the deduplication storage system. For example, the deduplication storage system may compare the fingerprint of the received data unit against the fingerprints in one or more container indexes. If no matching fingerprints are found in the searched container index(es), the received data unit may be added to a container, and an entry for the received data unit may be added to a container index corresponding to that container. However, if a matching fingerprint is found in a searched container index, it may be determined that a data unit identical to the received data unit is already stored in a container. In response to this determination, the reference count of the corresponding entry is incremented, and the received data unit is not stored in a container (as it is already present in one of the containers), thereby avoiding storing a duplicate data unit in the deduplication storage system. As used herein, the term “matching operation” may refer to an operation to compare fingerprints of a collection of multiple data units (e.g., from a particular backup data stream) against fingerprints stored in a container index.

In some examples, the deduplication storage system may process an inbound data stream to store a deduplicated copy (also referred to herein as a “snapshot”) of all data blocks in a source collection of data (also referred to herein as a “source item”) at a particular point in time. Further, in some examples, at least some data blocks in the source item may change over time. For example, a sales database (i.e., a source item) may be copied in a snapshot at a first point in time, and the sales database may subsequently be updated to include new records for additional sales transactions. Accordingly, the deduplication storage system may generate and store a sequence of snapshots to capture the changing state of the source item at different points in time. In some examples, some or all of the data units in the source item may be lost or rendered unusable (e.g., by a malware attack, a system failure, and so forth). In such examples, the stored snapshots may be used to recover at least some of the lost data of the source item. For example, if the sales database is lost due to a system failure, the most recent snapshot may be copied to regenerate the sales database as it existed at the time of that snapshot. However, such copying of the most recent snapshot will not recover the changes to the sales database that occurred after the creation of that most recent snapshot.

In some examples, one or more contiguous data units (also referred to herein as a “string”) included in a snapshot may become corrupted. As used herein, the term “corrupted” may refer to data unit(s) that do not include the correct data content. For example, a string of data unit(s) in a source item may be corrupted by a malware attack, and that corrupt string may be copied into each subsequent snapshot of that source item. As such, the recent snapshot(s) that include the corrupt string may not be usable to repair the source item. Therefore, the repair of the source item may have to be performed using an older snapshot that does not include the corrupt string. Further, because an older snapshot is less similar to the source item than a recent snapshot (e.g., due to the accumulation of changes to the source item over time), having to use an older snapshot is likely to result in a greater loss of data when recovering the source item.

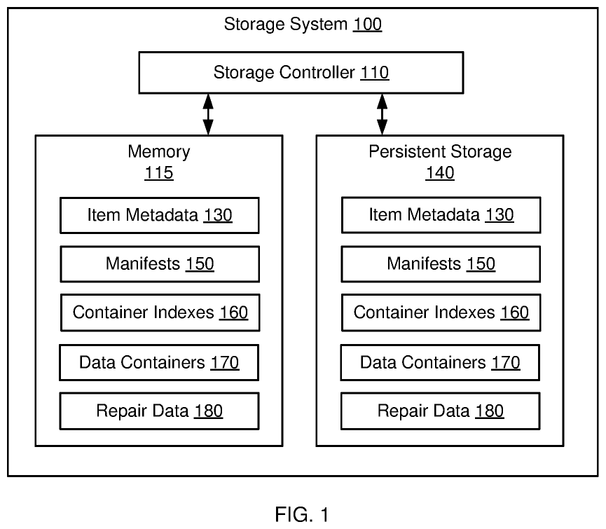

In accordance with some implementations of the present disclosure, a controller of a deduplication storage system may repair snapshots that include corrupt strings. The controller may identify a corrupt string included in a snapshot of a source item. For example, the controller may identify the corrupt string by matching a particular sequence of fingerprints corresponding to the data units included in the string. The controller may identify a first manifest that references the portion of the snapshot that includes the corrupt string. The controller may then select a comparison window (e.g., a set of data units including the corrupt string) from the first manifest, and may compare the comparison window to a set of candidate manifests associated with previous snapshots of the source item. The controller may assign a match score to each candidate manifest based on its similarity to the comparison window. If the candidate manifest having the highest match score also references the corrupt string, the controller may select a new comparison window from that candidate manifest, and may then compare the remaining candidate manifests to the new comparison window. Upon determining that the candidate manifest with the highest score does not reference the corrupt string, the controller may identify a non-corrupt string from that candidate manifest, and may determine that the non-corrupt string may be used as a repair for the corrupt string (i.e., can be used in the snapshot, instead of the corrupt string). Further, the controller may replace the reference to the corrupt string (in the first manifest) with a reference to the non-corrupt string. In this manner, the controller may repair the affected manifests with reduced (or no) loss of data, and may thereby improve the performance of the storage system. Various aspects of the disclosed repair process are discussed further below with reference to FIGS. 1-9.

### FIG. 1—Example Storage System

FIG. 1 shows an example of a storage system 100 that includes a storage controller 110, memory 115, and persistent storage 140, in accordance with some implementations. The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium).

As shown in FIG. 1, the memory 115 and the persistent storage 140 may store various data structures including at least item metadata 130, manifests 150, container indexes 160, data containers 170, and repair data 180. In some examples, copies of the item metadata 130, manifests 150, container indexes 160, the data containers 170, and the repair data 180 may be transferred between the memory 115 and persistent storage 140 (e.g., via read and write input/output (I/O) operations).

In some implementations, the storage system 100 may perform a data ingest operation to deduplicate received data. For example, the storage controller 110 may receive an inbound data stream including multiple data units, and may store at least one copy of each data unit in a data container 170 (e.g., by appending the data units to the end of the data container 170). In some examples, each data container 170 may be divided into entities, where each entity includes multiple stored data units. Further, in some examples, an inbound stream may be deduplicated and stored as a backup item.

In one or more implementations, the storage controller 110 may generate a fingerprint for each received data unit. For example, the fingerprint may include a full or partial hash value based on the data unit. To determine whether an incoming data unit is a duplicate of a stored data unit, the storage controller 110 may perform a matching operation to compare the fingerprint generated for the incoming data unit to the fingerprints in at least one container index 160. If a match is identified, then the storage controller 110 may determine that a duplicate of the incoming data unit is already stored by the storage system 100. The storage controller 110 may then store references to the previous data unit, instead of storing the duplicate incoming data unit.

In some implementations, the storage controller 110 may generate item metadata 130 to represent each backup item in a deduplicated form. In some examples, a set of backup items (represented by a set of item metadata 130) may be a sequence of snapshots that capture the changing data content of a source item (e.g., a storage volume) at multiple points in time. Each item metadata 130 may include identifiers for a set of manifests 150, and may indicate the sequential order of the set of manifests 150. The manifests 150 record the order in which the data units were received.

In some implementations, the manifests 150 may include a pointer or other information indicating the container index 160 that indexes each data unit. In some implementations, the container index 160 may include a fingerprint (e.g., a hash) of a stored data unit for use in a matching process of a deduplication process. Further, the container index 160 may indicate the location in which the data unit is stored. For example, the container index 160 may include information specifying that the data unit is stored at a particular offset in an entity, and that the entity is stored at a particular offset in a data container 170. The container index 160 may also include reference counts that indicate the number of manifests 150 that reference each data unit.

In some implementations, the storage controller 110 may receive a read request to access the stored data, and in response may access the item metadata 130 and manifests 150 to determine the sequence of data units that made up the original data. The storage controller 110 may then use pointer data included in a manifest 150 to identify the container indexes 160 that index the data units. Further, the storage controller 110 may use information included in the identified container indexes 160 (and information included in the manifest 150) to determine the locations that store the data units (e.g., data container 170, entity, offsets, etc.), and may then read the data units from the determined locations.

In some implementations, the storage controller 110 may identify a corrupt string included in a first snapshot of a source item, and may identify a manifest 150 that references the corrupt string. For example, the storage controller 110 may receive a message or command (e.g., from a user or program) that identifies a data range in a snapshot that includes a string of consecutive corrupt data units (e.g., based on a scan or analysis of the snapshot). In some examples, the location of the corrupt string may be specified as an offset and size in a given backup item (e.g., a particular item metadata 130). In such examples, the storage controller 110 may determine a particular manifest 150 that represents the offset and size in the item metadata 130.

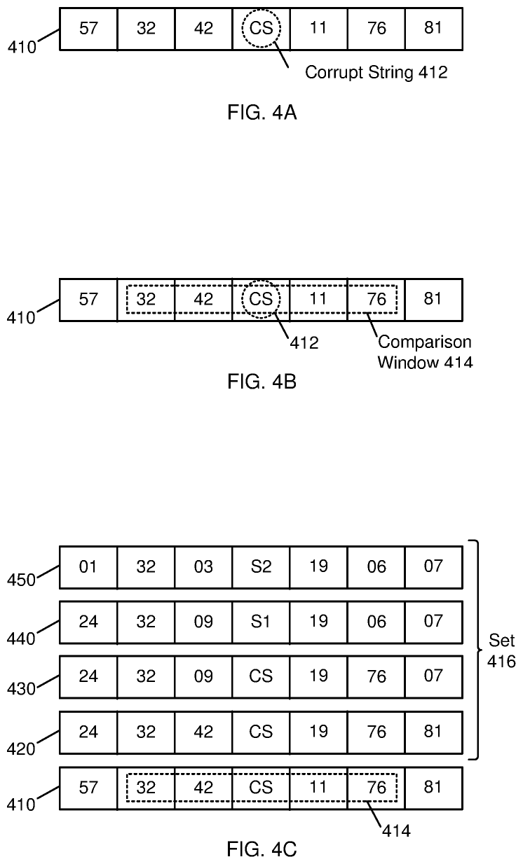

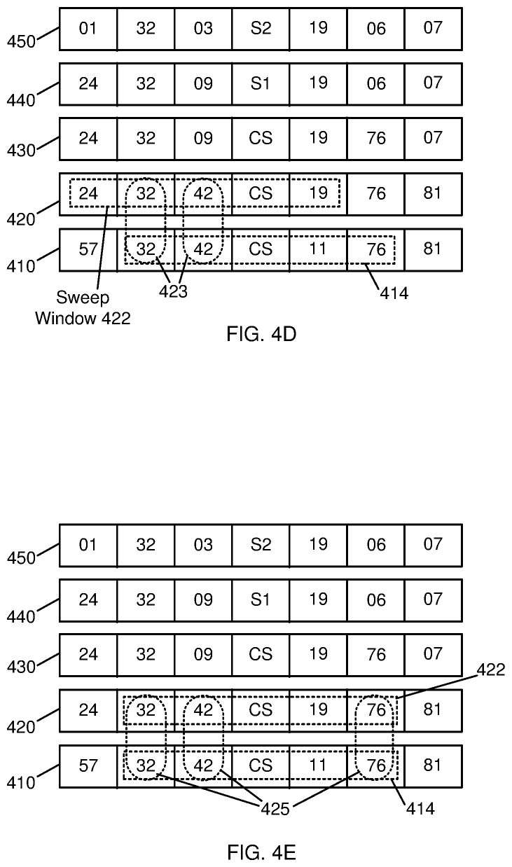

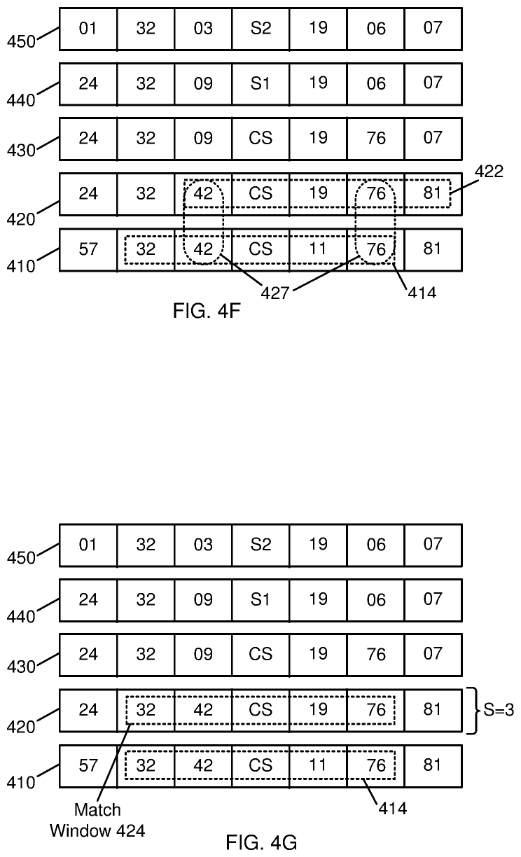

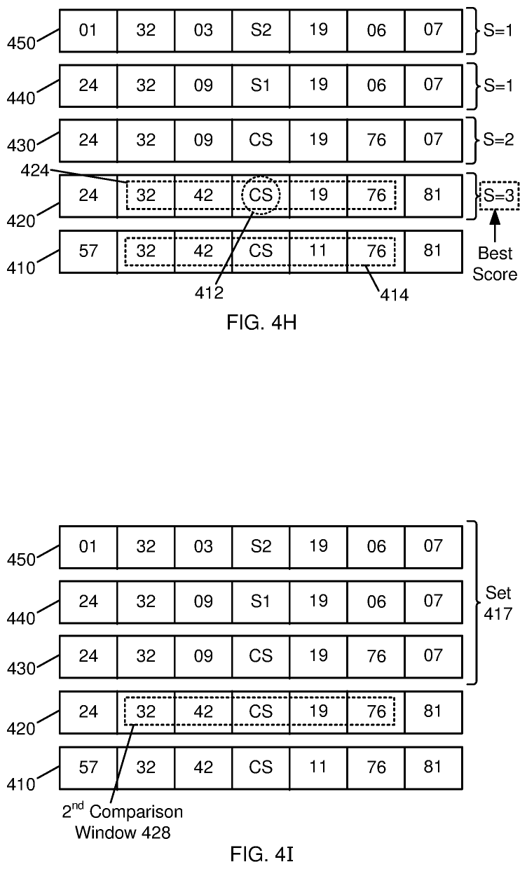

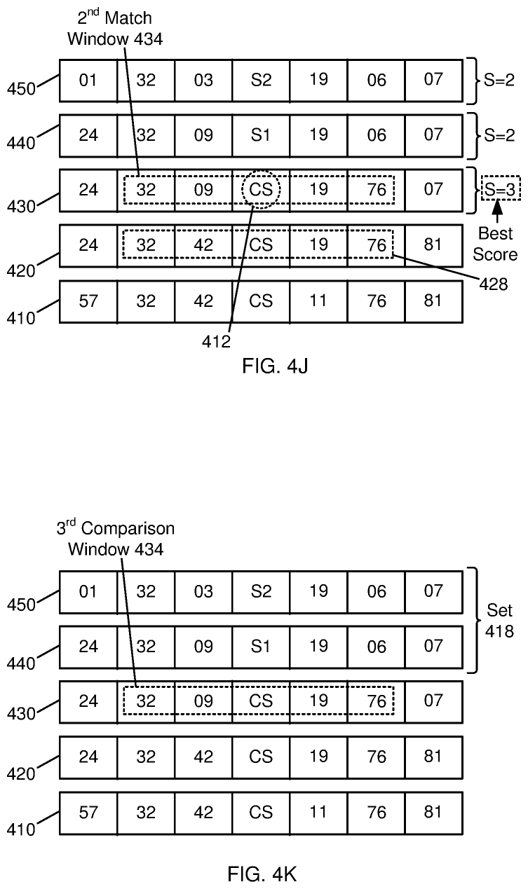

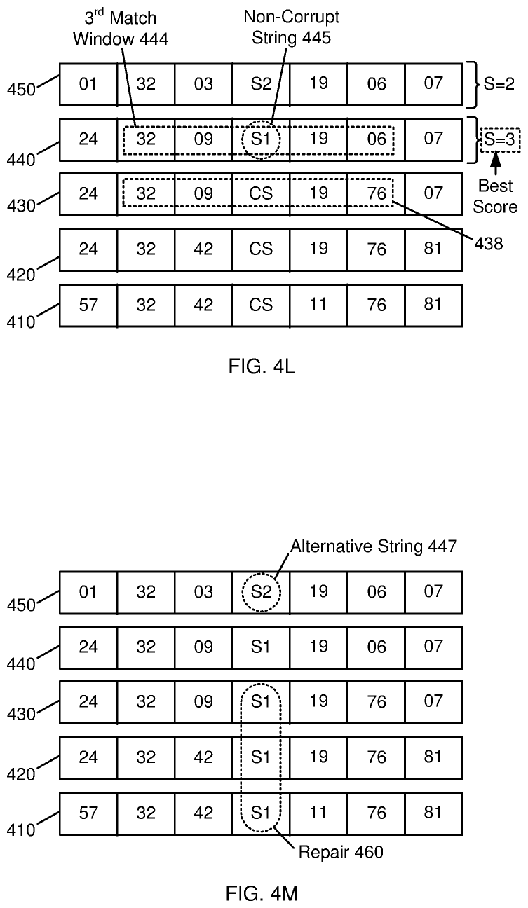

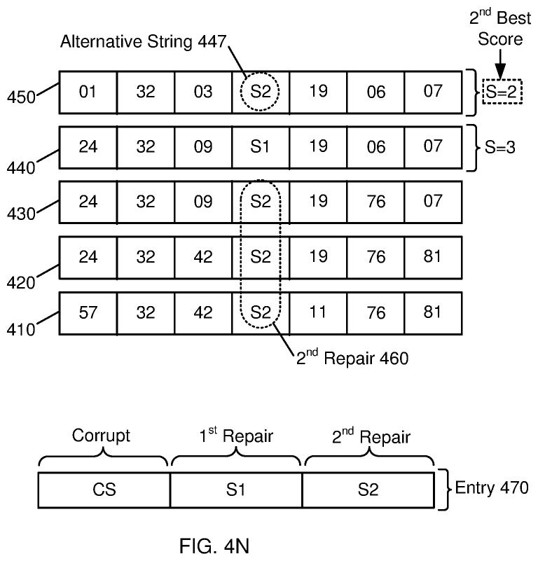

In some implementations, the storage controller 110 may select, in the manifest 150, a set of data unit references (also referred to herein as a “comparison window”) that includes a subset of references to the data units that make up the corrupt string. For example, the storage controller 110 may select a comparison window that includes a subset of the data unit references in the manifest 150, where the references for the corrupt string are located in the center of the comparison window (also referred to herein as the “center position”). An example implementation of a comparison window is described below with reference to FIG. 4B.

In some implementations, the storage controller 110 may identify a set of candidate manifests 150 that reference data units included in previous snapshots of the source item (e.g., multiple snapshots generated prior to the snapshot including the identified corrupt string). The storage controller 110 may compare the comparison window to each candidate manifest 150, and may assign a match score to each candidate manifest 150 based on its similarity to the comparison window. As used herein, the term “match score” may refer to a numerical value measuring the similarity between data units referenced in the comparison window and a set of data units referenced in the candidate manifest 150. For example, a match score may indicate how many data units are referenced in both the comparison window and a portion of the candidate manifest 150. An example calculation for a match score is described below with reference to FIGS. 4D-4G.

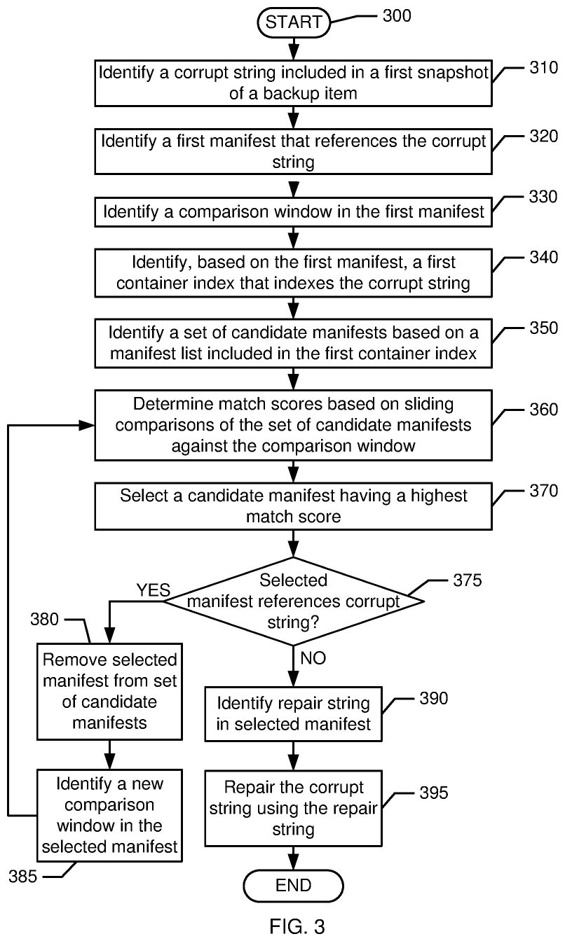

In some implementations, the storage controller 110 may identify the candidate manifest 150 having the highest match score (e.g., is most similar to the comparison window). Further, if the identified candidate manifest 150 also references the corrupt string, the storage controller 110 may select a new comparison window from the identified candidate manifest 150, and may then compare the remaining candidate manifests 150 to the new comparison window. If necessary, the storage controller 110 may repeat this process (e.g., determining that the candidate manifest 150 with the highest match score references the corrupt string, and then selecting a new comparison window) for multiple iterations, until it is determined that the candidate manifest 150 with the highest match score does not reference the corrupt string. Further, upon determining that the candidate manifest 150 with the highest match score does not reference the corrupt string, the storage controller 110 may select a non-corrupt string referenced in that candidate manifest 150. In some implementations, the non-corrupt string may be determined to include the correct data units that should be present in the snapshot, instead of the corrupt string. Accordingly, the storage controller 110 may use the non-corrupt string to repair the manifests 150 that referenced the corrupt string (e.g., by replacing references to the corrupt string with references to the non-corrupt string). A non-corrupt string that can repair the manifests 150 may be referred to herein as a “repair string.” In this manner, the storage controller 110 may repair the manifests 150 with reduced (or no) loss of data, and may thereby improve the performance of the storage system 100. An example process for repairing manifests included in snapshots is described below with reference to FIGS. 3 and 4A-4N.

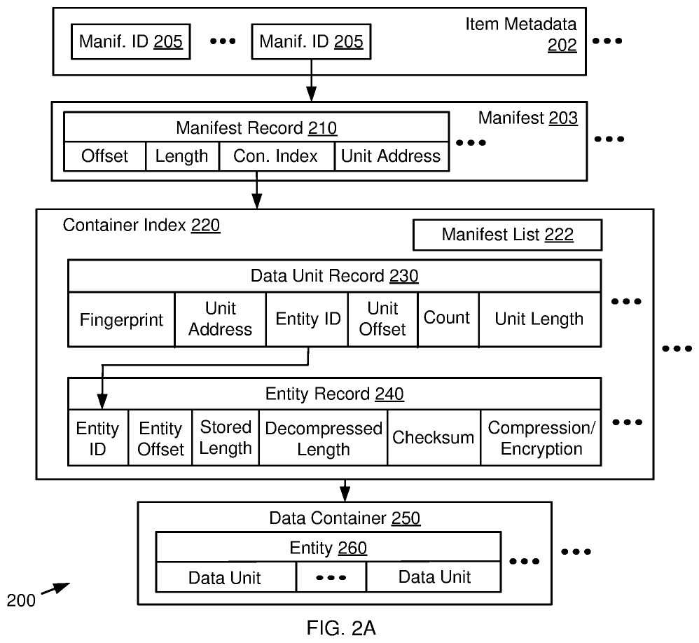

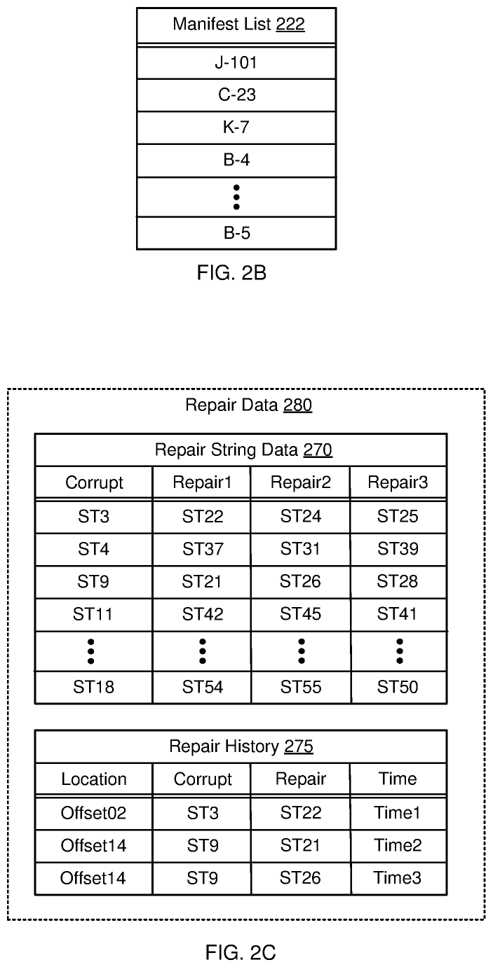

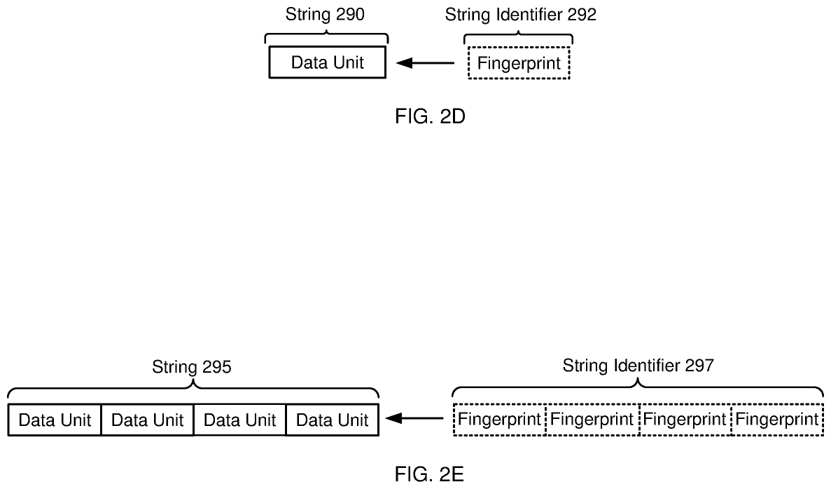

In some implementations, the storage controller 110 may identify multiple repair strings that may be used to attempt to repair a given corrupt string. For example, after comparing the candidate manifests 150 to the comparison window, the storage controller 110 may identify multiple candidate manifests 150 that do not reference the corrupt string, and may identify a different repair string from each of the multiple candidate manifests 150. In some implementations, the storage controller 110 may store information in an entry of the repair data 180 to record the multiple repair strings that may be used to attempt to repair the corrupt string. Subsequently, the storage controller 110 may compare received data strings to the repair string entries of the repair data 180. If a received data string matches a corrupt string recorded in the entries of the repair data 180, the storage controller 110 may attempt one or more repairs of the corrupt string using the repair strings listed in that entry. In some implementations, the repair data 180 may also include history data regarding repairs that have been attempted using repair strings. For example, the history data may record the corrupt string, the repair string, and the location for each attempted repair. Such history information may be used to roll back the attempted repairs (e.g., if an attempted repair is determined to be invalid). An example implementation of the repair data 180 is described below with reference to FIG. 2C.

### FIGS. 2A-2E—Example Data Structures

FIG. 2A shows an illustration of example data structures 200 used in deduplication, in accordance with some implementations. As shown, the data structures 200 may include item metadata 202, a manifest 203, a container index 220, and a data container 250. In some examples, the item metadata 202, the manifest 203, the container index 220, and the data container 250 may correspond generally to example implementations of item metadata 130, a manifest 150, a container index 160, and a data container 170 (shown in FIG. 1), respectively. In some examples, the data structures 200 may be generated and/or managed by the storage controller 110 (shown in FIG. 1).

In some implementations, the item metadata 202 may include multiple manifests identifiers 205. Each manifests identifier 205 may identify a different manifest 203. In some implementations, the manifests identifiers 205 may be arranged in a stream order (i.e., based on the order of receipt of the data units represented by the identified manifests 203). Further, the item metadata 202 may include a container list 204 associated with each manifest identifier 205. In some implementations, the container list 204 may include identifiers for a set of container indexes 220 that index the data units included in the associated manifest 203 (i.e., the manifest 203 identified by the associated manifest identifier 205).

Although one of each is shown for simplicity of illustration in FIG. 2A, data structures 200 may include a plurality of instances of item metadata 202, each including or pointing to one or more manifests 203. In such examples, data structures 200 may include a plurality of manifests 203. The manifests 203 may reference a plurality of container indexes 220, each corresponding to one of a plurality of data containers 250. Each container index 220 may comprise one or a plurality of data unit records 230, and one or a plurality of entity records 240.

As shown in FIG. 2A, in some examples, each manifest 203 may include one or more manifest records 210. Each manifest record 210 may include various fields, such as offset, length, container index, and unit address. In some implementations, each container index 220 may include any number of data unit record(s) 230 and entity record(s) 240. Each data unit record 230 may include various fields, such as a fingerprint (e.g., a hash of the data unit), a unit address, an entity identifier, a unit offset (i.e., an offset of the data unit within the entity), a reference count value, and a unit length. In some examples, the reference count value may indicate the number of manifest records 210 that reference the data unit record 230. Further, each entity record 240 may include various fields, such as an entity identifier, an entity offset (i.e., an offset of the entity within the container), a stored length (i.e., a length of the data unit within the entity), a decompressed length, a checksum value, and compression/encryption information (e.g., type of compression, type of encryption, and so forth). In some implementations, each data container 250 may include any number of entities 260, and each entity 260 may include any number of stored data units.

In some implementations, the unit address (included in the manifest record 210 and the data unit record 230) may be an identifier that deterministically identifies a particular data unit within a given container index 220. In some examples, the unit address may be a numerical value (referred to as the “arrival number”) that indicates the sequential order of arrival (also referred to as the “ingest order”) of data units being indexed in a given container index 220 (e.g., when receiving and deduplicating an inbound data stream). For example, the first data unit to be indexed in a container index 220 (e.g., by creating a new data unit record 230 for the first data unit) may be assigned an arrival number of “1,” the second data unit may be assigned an arrival number of “2,” the third data unit may be assigned an arrival number of “3,” and so forth. However, other implementations are possible.

In some implementations, a manifest record 210 may use a run-length reference format to represent a continuous range of data units (e.g., a portion of a data stream) that are indexed within a single container index 220. The run-length reference may be recorded in the unit address field and the length field of the manifest record 210. For example, the unit address field may indicate the arrival number of a first data unit in the data unit range being represented, and the length field may indicate a number N (where “N” is an integer) of data units, in the data unit range, that follow the data unit specified by arrival number in the unit address field. The data units in a data unit range may have consecutive arrival numbers (e.g., because they are consecutive in an ingested data stream). As such, a data unit range may be represented by an arrival number of a first data unit in the data unit range (e.g., specified in the unit address field of a manifest record 210) and a number N of further data units in the data unit range (e.g., specified in the length field of the manifest record 210). The further data units in the data unit range after the first data unit may be deterministically derived by calculating the N arrival numbers that sequentially follow the specified arrival number of the first data unit, where those N arrival numbers identify the further data units in the data unit range. In such examples, manifest record 210 may include an arrival number “X” in the unit address field and a number N in the length field, to indicate a data unit range including the data unit specified by arrival number X and the data units specified by arrival numbers X+i for i=0 through i=N, inclusive (where “i” is an integer). In this manner, the manifest record 210 may be used to identify all data units in the data unit range.

In one or more implementations, the data structures 200 may be used to retrieve stored deduplicated data. For example, a read request may specify an offset and length of data in a given file. These request parameters may be matched to the offset and length fields of a particular manifest record 210. The container index and unit address of the particular manifest record 210 may then be matched to a particular data unit record 230 included in a container index 220. Further, the entity identifier of the particular data unit record 230 may be matched to the entity identifier of a particular entity record 240. Furthermore, one or more other fields of the particular entity record 240 (e.g., the entity offset, the stored length, checksum, etc.) may be used to identify the container 250 and entity 260, and the data unit may then be read from the identified container 250 and entity 260.

In some implementations, each container index 220 may include a manifest list 222. The manifest list 222 may be a data structure to store a set of entries, where each entry stores information regarding a different manifest 203 (or manifest record 210) that is indexed by the container index 220 (including the manifest list 222). For example, each time that the container index 220 is generated or updated to include information regarding a particular manifest record 210, the manifest list 222 in that container index 220 is updated to store an identifier of that manifest record 210. Further, the entries of the manifest list 222 may be arranged in their respective order of entry into the manifest list 222 (also referred to herein as the “arrival order” of the entries). In some examples, when a container index 220 is no longer associated with the manifest record 210, the identifier of the manifest record 210 is removed from the manifest list 222.

Referring now to FIG. 2B, shown is an example implementation of a manifest list 222. As shown in FIG. 2A, in some implementations, each entry of the manifest list 222 may only store a manifest identifier 205. However, other examples are possible. For example, each entry of the manifest list 222 may instead include both a manifest identifier 205 and at least one data unit range (e.g., a set of one or more data units that are included in the manifest 203 and that are indexed by the container index 220).

Referring now to FIG. 2C, shown is an example implementation of repair data 280. The repair data 280 may correspond generally to an example implementation of the repair data 180 (shown in FIG. 1). As shown in FIG. 2C, the repair data 280 may include a repair string data 270 and a repair history 275. The repair string data 270 and the repair history 275 may be stored in separate data structures (e.g., tables, databases, formatted text files, and so forth).

In some implementations, the repair string data 270 may include multiple entries. Each entry of the repair string data 270 may store an identifier of a corrupt string, and may also store identifiers for a corresponding set of repair strings (i.e., the non-corrupt strings that have been determined to be possible repair replacements for the corrupt string). In some implementations, the string identifiers (i.e., a unique identifier of a corrupt string or a repair string) may include a fingerprint corresponding to each data unit in the string. For example, FIG. 2D illustrates an example string 290 that includes a single data unit. Accordingly, as shown in FIG. 2D, the string identifier 292 is a single fingerprint corresponding to the single data unit in the string 290. In another example, FIG. 2E illustrates an example string 295 that includes a continuous sequence of four data units. Accordingly, as shown in FIG. 2E, the string identifier 297 includes a sequence of four fingerprints that correspond to the data units in the string 295.

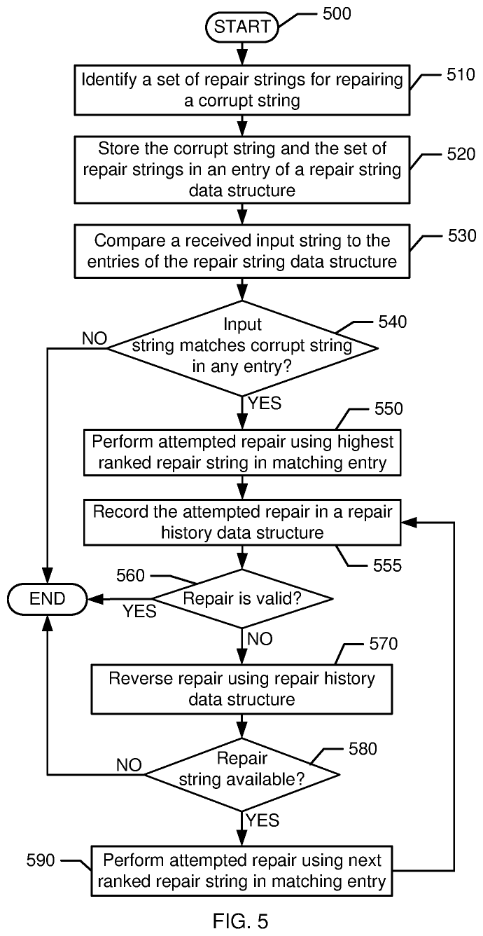

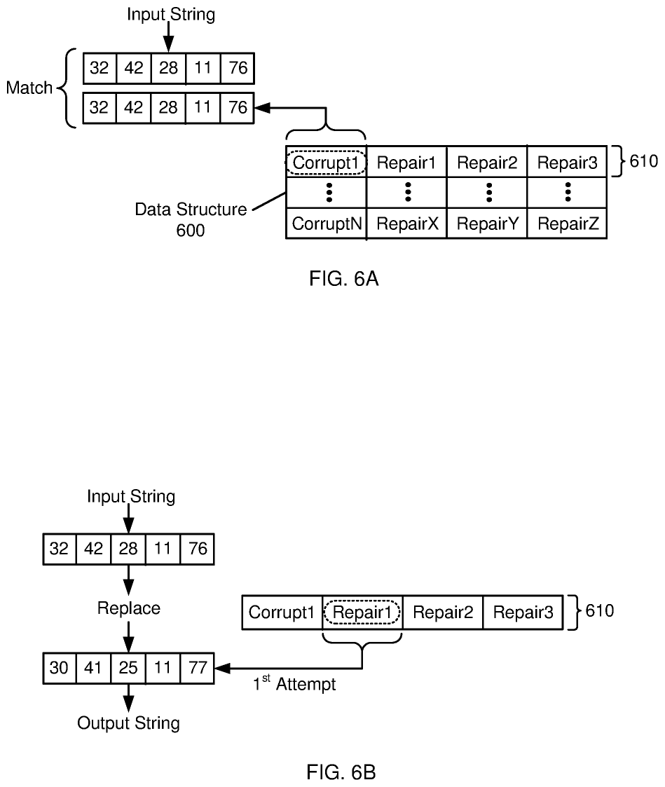

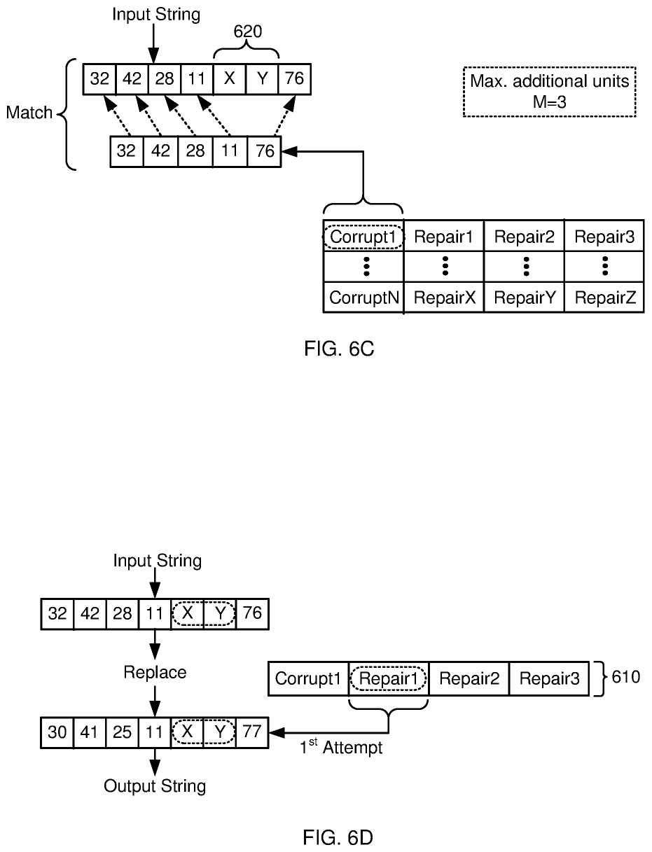

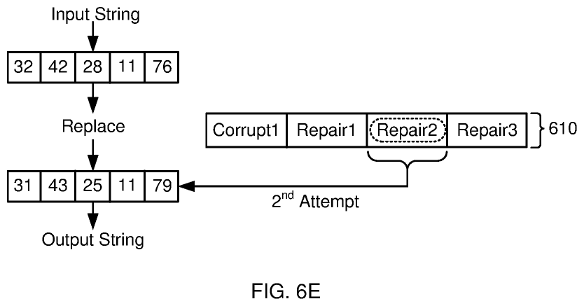

Referring again to FIG. 2C, an entry may be added to the repair string data 270 upon identifying one or more repair strings for use in repairing a particular corrupt string. Subsequently, upon receiving a new data string to be stored, the received string may be compared to the entries of the repair string data 270. If the received data string matches a corrupt string recorded in the entries of the repair string data 270, the received data string may be replaced with a repair string listed in the matching entry. An example process for performing a repair using the repair string data 270 is described below with reference to FIGS. 5 and 6A-6D.

In some implementations, the repair history 275 may include multiple entries. Each entry of the repair history 275 may store information regarding a different repair operation that has been attempted to repair a corrupt string. For example, an entry of the repair history 275 may record the location for an attempted repair (e.g., an offset, a container identifier, an address, etc.), an identifier of the corrupt string, an identifier of the repair string, and a time stamp for the repair operation. In some implementations, the repair history 275 may be used to roll back a repair recorded in an entry. For example, the repair recorded in an entry may be rolled back (i.e., reversed) by overwriting the repair string with the corrupt string at the recorded location.

### FIGS. 3 and 4A-4N—Example Process for Repairing Snapshots

FIG. 3 shows is an example process 300 for repairing snapshots in a deduplication storage system, in accordance with some implementations. In some examples, the process 300 may be performed using the storage controller 110 (shown in FIG. 1). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. In some implementations, the process 300 may be executed by a single processing thread. In other implementations, the process 300 may be executed by multiple processing threads in parallel (e.g., concurrently using the work map and executing multiple housekeeping jobs).

Block 310 may include identifying a corrupt string included in a first snapshot of a backup item. Block 320 may include identifying a first manifest that references the corrupt string. In some implementations, the manifest may reference a total number T (where “T” is an integer) of data units, and may record the order of receipt of the T data units into the manifest. For example, referring to FIGS. 1 and 4A, the storage controller 110 receives an indication (e.g., a user command, software message, etc.) identifying a data range in a snapshot (e.g., an offset and a length in a backup item) that includes a corrupt string 412 (labeled “CS”). The corrupt string 412 may include a number N (where “N” is an integer) of corrupt data units. Note that, for the sake of illustration, the corrupt string 412 is illustrated as a single corrupt data unit in FIG. 4A (i.e., N=1). However, in other examples, the corrupt string 412 may include multiple consecutive corrupt data units (i.e., N>1). In some examples, the presence of the corrupt string 412 may be detected by a malware scan, an integrity test, and so forth. The storage controller 110 reads the item metadata 130 that represents the snapshot, identifies the manifest 410 that references the corrupt string 412, and loads the manifest 410 into memory 115.

Referring again to FIG. 3, block 330 may include identifying a comparison window in the first manifest. In some implementations, the comparison window may have a width W (where “W” is an integer) indicating the number of data units referenced in the comparison window, where the width W is smaller than the total number “T” of data units referenced in the manifest. Further, in some implementations, the width W may be larger than the number N of data units in the corrupt string. For example, referring to FIGS. 1 and 4B, the storage controller selects, in the manifest 410, a comparison window 414 that includes the corrupt string 412. In some implementations, the corrupt data unit 412 is referenced in the center position of the comparison window 414. However, other sizes and/or arrangements of the comparison window 414 are possible.

Referring again to FIG. 3, block 340 may include identifying, based on the first manifest, a first container index that indexes the corrupt string. Block 350 may include identifying a set of candidate manifests based on a manifest list included in the first container index. For example, referring to FIGS. 1-2A and 4C, the storage controller 110 reads the manifest 150 to identify the container index 160 that indexes the corrupt string 412, and then loads the container index 160 into memory 115. Further, the storage controller 110 reads the manifest list 222 (stored in the container index 160) to identify a set 416 of the manifests that are indexed by the container index 160 (e.g., candidate manifests 420, 430, 440, 450). In some implementations, the set 416 is arranged in arrival order (e.g., in order of entry into the manifest list 222). The storage controller 110 loads each candidate manifest in the set 416 into memory 115 (e.g., one at a time or as a group). In some examples, each candidate manifest in the set 416 may reference data units in a different snapshot of a particular source item. In such examples, each candidate manifest may record the order of data units in a particular portion of the source item at a different point in time (i.e., corresponding to each snapshot).

Referring again to FIG. 3, block 360 may include determining match scores based on sliding comparisons of the set of candidate manifests against the comparison window. Block 370 may include selecting a candidate manifest having a highest match score. As used herein, a “sliding comparison” may refer to an operation including sliding a selection window (also referred as a “sweep window”) across a candidate manifest to select different subsets of data units referenced in the candidate manifest, and comparing each subset of data units against the data units referenced in a current comparison window. In some implementations, the sweep window used in the sliding comparison may have a width equal to the width W of the comparison window. For example, referring to FIG. 4D, the controller selects the candidate manifest 420 (in the set 416) that most closely precedes the manifest 410 (identified at block 320). The controller initiates the sliding comparison of the candidate manifest 420 by placing a sweep window 422 in a first position, thereby selecting the left-most W data units referenced in the candidate manifest 420 (e.g., the earliest W data units in arrival order), where W is the width of the comparison window 414. The controller then determines a similarity value between the comparison window 414 and the sweep window 422 in the first position. In some implementations, the similarity value may be calculated as the total number of non-corrupt data units (i.e., data units that are not included in the corrupt string 412) in the comparison window 414 that are also included in the current sweep window 422. For example, as shown in FIG. 4D, two non-corrupt data units 423 (i.e., data units “32” and “42”) are referenced in both the comparison window 414 and the sweep window 422. Accordingly, the similarity value for the sweep window 422 in the first position is equal to two.

Referring now to FIG. 4E, the controller continues the sliding comparison of the candidate manifest 420 by sliding the sweep window 422 by one data unit reference right-ward into a second position. As shown in FIG. 4E, the controller then identifies three non-corrupt data units 425 (i.e., data units “32,” “42,” and “76”) are referenced in both the comparison window 414 and the sweep window 422 in the second position. Accordingly, the similarity value for the sweep window 422 in the second position is equal to three.

Referring now to FIG. 4F, the controller completes the sliding comparison of the candidate manifest 420 by sliding the sweep window 422 by one data unit reference right-ward into a third position. As shown in FIG. 4F, the controller then identifies two non-corrupt data units 427 (i.e., data units “42” and “76”) are referenced in both the comparison window 414 and the sweep window 422 in the third position. Accordingly, the similarity value for the sweep window 422 in the third position is equal to two.

Referring now to FIG. 4G, the controller determines that the highest similarity score (i.e., three) in the sliding comparison of the candidate manifest 420 was obtained in the second position of the sweep window 422 (shown in FIG. 4E). Accordingly, the controller identifies the second position of the sweep window 422 as the match window 424 of the candidate manifest 420. As used herein, a “match window” may refer to a subset of data unit references in a candidate manifest that have a highest similarity with respect to the data unit references in a current comparison window (i.e., the comparison window being used for a sliding comparison). Further, as shown in FIG. 4G, the controller sets the match score of the candidate manifest 420 to three (“S=3”), corresponding to the similarity score for the match window 424.

Referring now to FIG. 4H, the controller performs sliding comparisons of the set 416 (i.e., manifests 420, 430, 440, and 450) against the comparison window 414, and determines the match scores for the candidate manifests. Further, the controller selects the candidate manifest 420 having the best match score (i.e., three) of the set 416.

Referring again to FIG. 3, decision block 375 may include determining whether the selected manifest references the corrupt string (identified at block 310). If it is determined that the selected manifest references the corrupt string (“YES”), the process 300 may continue at block 380, including removing the selected manifest from the set of candidate manifests. Block 385 may include identifying a new comparison window in the selected manifest. After block 385, the process 300 may return to block 360 (i.e., to determine new match scores based on sliding comparisons of the remaining candidate manifests against the new comparison window). In some examples, blocks 360, 370, 375, 380 and 385 may be repeated in one or more loops, until reaching a negative determination at decision block 375 (i.e., upon determining that a selected candidate manifest does not reference the corrupt string). For example, referring to FIG. 4H, the controller determines that, in the candidate manifest 420 (selected at block 370), the match window 424 includes a reference to the corrupt string 412 (which was also referenced in the manifest 410). In response to this determination, as shown in FIG. 4I, the controller removes the candidate manifest 420 from the set 416 to obtain a reduced set 417, and selects the match window 424 as a second comparison window 428 in the candidate manifest 420.

Referring now to FIG. 4J, the controller performs sliding comparisons of the reduced set 417 of candidate manifests (i.e., manifests 430, 440, 450) against the second comparison window 428, and determines the match scores for these candidate manifests. The controller then determines that candidate manifest 430 has the best match score (i.e., three), corresponding to the similarity score for the second match window 434 in the candidate manifest 430. Further, the controller determines that the second match window 434 includes a reference to the corrupt string 412. In response to this determination, as shown in FIG. 4K, the controller removes the candidate manifest 430 from the reduced set 417 to obtain a second reduced set 418, and selects the second match window 434 as a third comparison window 438 in the candidate manifest 430.

Referring again to FIG. 3, if it is determined at decision block 375 that the selected manifest does not reference the corrupt string (“NO”), the process 300 may continue at block 390, including identifying a repair string referenced in the selected manifest. Block 395 may include replacing, in the first manifest, the reference(s) to the corrupt string with reference(s) to the identified repair string. After block 395, the process 300 may be completed. For example, referring to FIG. 4L, the controller performs sliding comparisons of the second reduced set 418 (i.e., manifests 440, 450) against the third comparison window 438, and determines the match scores for these candidate manifests. The controller then determines that candidate manifest 440 has the best match score (i.e., three), corresponding to the similarity score for the third match window 444 in the candidate manifest 440. Further, the controller determines that the third match window 444 does not include a reference to the corrupt string 412, but instead references a non-corrupt string 445 (labeled “NS”). In response to this determination, as shown in FIG. 4M, the controller performs a repair 460 using the non-corrupt string 445 (i.e., by replacing the reference(s) to the corrupt string 412 with reference(s) to the non-corrupt string 445) in each of the manifests 410, 420, 430 (i.e., the manifests that were previously determined to include the corrupt data units at decision block 375 shown in FIG. 3). In this manner, the controller may repair the affected manifests with reduced (or no) loss of data, and may thereby improve the performance of a system including the stored data.

In some implementations, the controller may determine whether the repaired manifests 410, 420, 430 are valid (i.e., contain non-corrupt data). For example, after performing the repair 460 (i.e., using the non-corrupt string 445), the controller may prompt a human user to review or otherwise evaluate the repaired data, and to confirm that the repaired data is valid. In another example, after performing the repair 460, the controller may perform automated testing to determine whether the repaired data is valid. In some implementations, if it is determined that the repair 460 is not valid, the controller may roll back (i.e., reverse) the repair 460 to return the manifests 410, 420, 430 to their previous conditions (i.e., including the corrupt string 412). Further, the controller may perform another repair using the candidate manifest that has the next highest match score, and which does not include the corrupt string 412. For example, referring to FIG. 4N, the controller determines that the candidate manifest 450 with the second-best match score (i.e., S=2) includes the alternative string 447 (i.e., instead of the corrupt string 412). Accordingly, the controller may attempt a second repair 462 using the alternative string 447.

In some implementations, the controller may create an entry in a stored data structure (e.g., repair string data 270 shown in FIG. 2C) to record one or more repair strings that have been determined to be usable to repair a particular corrupt string (e.g., using the process 300 shown in FIG. 3). For example, an entry may record the identifier for a given corrupt string (e.g., corrupt string 412), and may also record identifiers for multiple repair strings (e.g., non-corrupt string 445 and alternative string 447). In some implementations, the entry may indicate an order of preference or rank for the repair strings (e.g., a first rank or preference for the non-corrupt string 445, and a second rank or preference for the alternative string 447). Subsequently, if a received data string matches the corrupt string 412 recorded in the entry, the controller may use the entry to perform one or more attempted repairs using the repair strings recorded in the entry. An example process for using stored repair data is described below with reference to FIG. 5.

In some implementations, determining match scores based on sliding comparisons (e.g., in block 360 shown in FIG. 3) may be performed using different sizes of comparison windows. For example, a controller may perform an initial set of sliding comparisons using a first width of the comparison window, and may be unable to determine a best match window (in a candidate manifest) based on the match scores (e.g., if all match scores are equal, if all match scores are below a minimum threshold for a useful match score, and so forth). In this example, the controller may initiate a second set of sliding comparisons using a larger width of the comparison window, and may again attempt to determine the best match window based on the match scores. This process may be repeated (with increasing widths of the comparison window) until reaching a valid result from the sliding comparisons (i.e., determining a best match window in a candidate manifest).

It is noted that implementations are not limited by the examples shown in FIGS. 4A-4N. For example, it is contemplated that any or all of the comparison window 414 may not be centered in manifest 410. Similarly, the match window 424 may not be centered in the candidate manifest 420, and the second match window 434 may not be centered in the candidate manifest 430. Further, although FIG. 4H shows an example in which the selected candidate manifest 420 with the best match score is directly adjacent to the first manifest 410 (including the comparison window 414), it is contemplated that, in other examples, the selected candidate manifest may not be adjacent to the manifest including the comparison window. For example, if instead the candidate manifest 420 had a lower match score than the candidate manifest 430, then candidate manifest 430 may be selected for having the highest match score in the set 416. In this example, the candidate manifest 420 may not reference the same stream of data units (e.g., in a particular source item) that is referenced by the other candidate manifests in the set 416.

### FIGS. 5 and 6A-6E—Example Process for Using an Alias List

FIG. 5 shows is an example process 500 for using stored repair data in a deduplication storage system, in accordance with some implementations. In some examples, the process 500 may be performed using the storage controller 110 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. In some implementations, the process 500 may be executed by a single processing thread. In other implementations, the process 500 may be executed by multiple processing threads in parallel (e.g., concurrently using the work map and executing multiple housekeeping jobs).

Block 510 may include identifying a set of repair strings for repairing a corrupt string. Block 520 may include storing the corrupt string and the set of repair strings in an entry of a repair string data structure. For example, referring to FIGS. 4A-4N, a controller identifies a corrupt string 412 in a snapshot, identifies the manifest 410 that references the corrupt string 412, and selects a comparison window 414 in the manifest 410. The controller identifies a container index that indexes the corrupt string 412, and identifies a set 416 of candidate manifests that are indexed by the container index (e.g., using the manifest list 222 shown in FIG. 2B). Further, the controller determines match scores based on sliding comparisons of the set 416 of candidate manifests against the comparison window 414, selects the match window 424 in the candidate manifest 420 with the highest match score, and determines whether the match window 424 includes a reference to the corrupt data unit 412. If so, the controller performs one or more iterations of selecting a comparison window, performing sliding comparisons of the remaining candidate manifests, and selecting match windows from the remaining candidate manifests. Further, the controller determines that repair strings 445, 447 may be used to repair the corrupt string 412, and records the identifiers (e.g., fingerprints) for the corrupt string 412 and repair strings 445, 447 in an entry 470 of a stored data structure (e.g., repair string data 270 shown in FIG. 2C).

Referring again to FIG. 5, block 530 may include comparing a received data string to the entries of the repair string data structure. Decision block 540 may include determining whether the received input string matches the corrupt string recorded in any entry of the repair string data structure. If not (“NO”), the process 500 may be completed. Otherwise, if it is determined that the received input string matches the corrupt string recorded in an entry (“YES”), the process 500 may continue at block 550, including performing an attempted repair using the highest ranked repair string recorded in that matching entry.

In some implementations, a match to an entry of the repair string data structure may be identified if the received input string and the corrupt string in the entry both include the same sequence of data units. For example, referring to FIG. 6A, a controller compares a received input string against index fields (e.g., the first field in each entry) of a stored data structure 600. The controller determines that the string “Corrupt1” stored in the index field of entry 610 is a match for the received input string, and thereby determines that the received input string was previously identified as being a corrupt string. Further, referring to FIG. 6B, the controller reads the entry 610 to determine the highest ranked repair string “Repair1” recorded for that corrupt string. The controller then performs a first attempted repair by replacing the corrupt string with the highest ranked repair string from the entry 610. The stored data structure 600 may correspond generally to an example implementation of the repair string data 270 shown in FIG. 2C.

In some implementations, a match to an entry of the repair string data structure may be identified if the received input string includes a modified version of the corrupt string stored in the entry. The modified version of the corrupt string may include a first set of data units and a second set of data units, where the first set of data units is identical to the corrupt string recorded in the entry of the repair string data structure, and where the second set of data units includes a number M of additional data units that are not included in the corrupt string recorded in the first entry, where M is a positive integer. For example, referring now to FIG. 6C, the received input string includes the same sequence of data units as the string “Corrupt1” stored in the index field of entry 610 (in stored data structure 600), and also includes two additional data units 620 (i.e., units “X” and “Y”) that are not included in the string “Corrupt1.” Further, the maximum number of additional data units M is equal to 3 in the example shown in FIG. 6C. Therefore, because the number of additional data units 620 (i.e., two) is less than M, a controller identifies a match between the received input string and the string “Corrupt1” stored in the index field of entry 610. Furthermore, referring to FIG. 6D, the controller reads the entry 610 to determine the highest ranked repair string “Repair1” recorded for that corrupt string. The controller then performs a first attempted repair by replacing the matching portions of the input string (i.e., the data units that are also included in the string “Corrupt1”) with the matching portions of the highest ranked repair string from the entry 610, while leaving the non-matching portions (i.e., data units 620 “X” and “Y”) in their original positions within the input string. Accordingly, the output string includes the data units 620 “X” and “Y” in the same locations that they occupied in the input string.

Referring again to FIG. 5, block 555 may include recording the attempted repair in a repair history data structure. For example, referring to FIG. 2C, the controller may record information regarding the attempted repair in an entry of the repair history 275. The recorded information may include the location of the repair, the corrupt string that was replaced in the repair, the repair string that was the replacement in the repair, and a time stamp of the repair.

Referring again to FIG. 5, decision block 560 may include determining whether the attempted repair is valid. If so (“YES”), the process 500 may be completed. Otherwise, if it is determined that the attempted repair is not valid (“NO”), the process 500 may continue at block 570, including reversing the repair using a repair history data structure. For example, referring to FIG. 2C, the controller determines that the attempted repair is not valid, and in response obtains information regarding the attempted repair from the repair history 275. Based on the obtained repair information, the controller reverses the attempted repair by replacing the repair string with the corrupt string at the repair location.

Referring again to FIG. 5, decision block 580 may include determining whether another repair string is available. If not (“NO”), the process 500 may be completed. Otherwise, if it is determined that another repair string is available (“YES”), the process 500 may continue at block 590, including attempting another repair using the next-ranked string in the matching entry. After block 590, the process 500 may return to block 555 (i.e., to record the attempted repair in the repair history data structure), and may then proceed to decision block 560 (i.e., to again determine whether the attempted repair is valid). For example, referring to FIG. 6E, the controller reads the entry 610 of stored data structure 600 to determine the second-ranked repair string “Repair2” corresponding to corrupt string “Corrupt1.” The controller then performs a second attempted repair by replacing the corrupt string with the second-ranked repair string from the entry 610. In some implementations, the process 500 may repeat multiple loops of blocks 555, 560, 570, 580, 590 until reaching a determination that the repair is valid (at decision block 560), or a determination that no more repair strings are available (at decision block 580). When a valid repair is performed, the corrupt string is not stored as part of the deduplicated backup item (representing the received stream). In this manner, some implementations may reduce the amount of corrupt data stored in the storage system 100. Further, some implementations may reduce the loss of data and the performance impact associated with recovery from each instance of the corrupt string.

In some implementations, determining whether the attempted repair is valid (e.g., at decision block 560) may be based on input by a human user. For example, the controller may generate a request or alert (e.g., via a user interface) to ask the user to review or evaluate the repaired data, and to confirm that the repaired data is valid (e.g., not corrupt). Further, the request may ask the user whether to attempt another repair operation (e.g., using a different repair string stored in the entry 610). In other implementations, the controller may perform an automated test process to evaluate the repaired data, and may automatically perform another repair operation upon determining that the prior repair was invalid. For example, such automated testing may include file system consistency checks, application format verification testing, and so forth.

In some implementations, performing a valid repair using process 500 may prevent the corrupt string from being stored as part of the deduplicated backup item (representing the received stream). In this manner, some implementations may reduce the amount of corrupt data stored in the storage system 100. Further, some implementations may reduce the loss of data and the performance impact associated with recovery from each instance of the corrupt string.

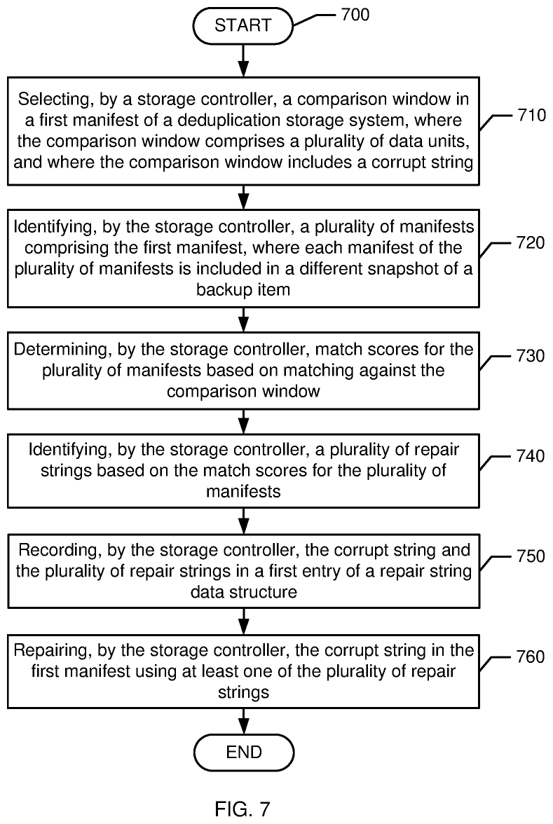

### FIG. 7—Example Process for Snapshot Repair

FIG. 7 shows is an example process 700 for snapshot repair, in accordance with some implementations. In some examples, the process 700 may be performed using the storage controller 110 (shown in FIG. 1). The process 700 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 710 may include selecting, by a storage controller, a comparison window in a first manifest of a deduplication storage system, where the comparison window comprises a plurality of data units, and where the comparison window includes a corrupt string. Block 720 may include identifying, by the storage controller, a plurality of manifests comprising the first manifest, where each manifest of the plurality of manifests is included in a different snapshot of a backup item. For example, referring to FIGS. 4A-4C, a controller identifies a corrupt string 412 in a snapshot, identifies the manifest 410 that references the corrupt string 412, and selects a comparison window 414 in the manifest 410. The controller identifies a container index that indexes the corrupt string 412, and identifies a set 416 of candidate manifests that are indexed by the container index (e.g., using the manifest list 222 shown in FIG. 2B).

Referring again to FIG. 7, block 730 may include determining, by the storage controller, match scores for the plurality of manifests based on matching against the comparison window. For example, referring to FIGS. 4D-4K, the controller determines match scores based on sliding comparisons of the set 416 of candidate manifests against the comparison window 414, selects the match window 424 in the candidate manifest 420 with the highest match score, and determines whether the match window 424 includes a reference to the corrupt data unit 412. If so, the controller performs one or more iterations of selecting a comparison window, performing sliding comparisons of the remaining candidate manifests, and selecting match windows from the remaining candidate manifests.

Referring again to FIG. 7, block 740 may include identifying, by the storage controller, a plurality of repair strings based on the match scores for the plurality of manifests. Block 750 may include recording, by the storage controller, the corrupt string and the plurality of repair strings in a first entry of a repair string data structure. For example, referring to FIGS. 4L-4M, the controller determines that repair strings 445, 447 may be used to repair the corrupt string 412, and records the identifiers (e.g., fingerprints) for the corrupt string 412 and repair strings 445, 447 in an entry 470 of a stored data structure (e.g., stored data structure 600 shown in FIG. 6A).

Referring again to FIG. 7, block 760 may include repairing, by the storage controller, the corrupt string in the first manifest using at least one of the identified plurality of repair strings. After block 760, the process 700 may be completed. For example, referring to FIG. 6A, a controller compares a received input string against index fields of the stored data structure 600. The controller determines that the string “Corrupt1” stored in the index field of entry 610 is a match for the received input string, and thereby determines that the received input string was previously identified as being a corrupt string. Further, referring to FIG. 6B, the controller reads the entry 610 to determine the highest ranked repair string “Repair1” recorded for that corrupt string. The controller performs a first attempted repair by replacing the corrupt string with the highest ranked repair string from the entry 610. Further, the controller may determine whether the first attempted repair is valid (e.g., based on input by a human user or an automated test process). If it is determined that the first attempted repair is not valid, the controller reverses the first attempted repair (e.g., using the repair history 275 shown in FIG. 2C). Further, referring to FIG. 6E, the controller reads the entry 610 to determine the second-ranked repair string “Repair2” corresponding to corrupt string “Corrupt1,” and then performs a second attempted repair by replacing the corrupt string with the second-ranked repair string from the entry 610. In some examples, multiple repairs may be attempted until reaching a determination that a repair is valid, or a determination that no more repair strings are available.

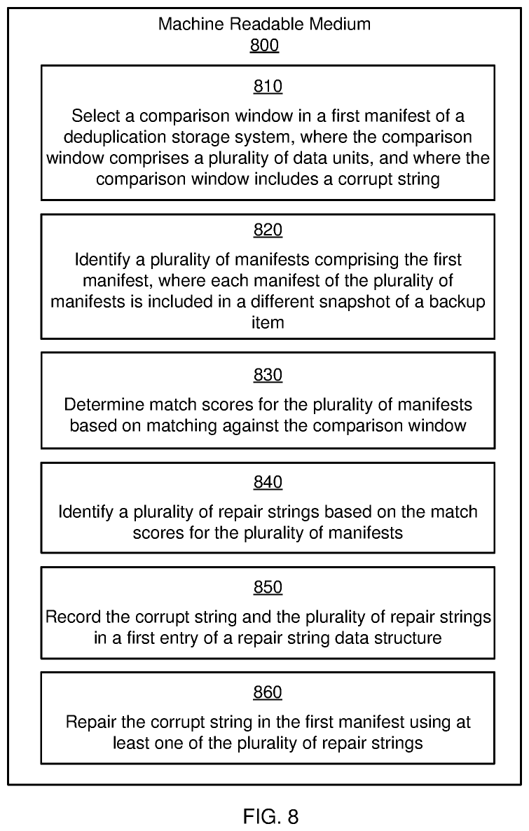

### FIG. 8—Example Machine-Readable Medium

FIG. 8 shows a machine-readable medium 800 storing instructions 810-850, in accordance with some implementations. The instructions 810-850 can be executed by a single processor, multiple processors, a single processing engine, multiple processing engines, and so forth. The machine-readable medium 800 may be a non-transitory storage medium, such as an optical, semiconductor, or magnetic storage medium. The instructions 810-850 may correspond generally to the examples described above with reference to blocks 710-750 (shown in FIG. 7).

Instruction 810 may be executed to select a comparison window in a first manifest of a deduplication storage system, where the comparison window comprises a plurality of data units, and where the comparison window includes a corrupt string. Instruction 820 may be executed to identify a plurality of manifests comprising the first manifest, where each manifest of the plurality of manifests is included in a different snapshot of a backup item.

Instruction 830 may be executed to determine match scores for the plurality of manifests based on matching against the comparison window. Instruction 840 may be executed to identify a plurality of repair strings based on the match scores for the plurality of manifests. Instruction 850 may be executed to record the corrupt string and the plurality of repair strings in a first entry of a repair string data structure. Instruction 860 may be executed to repair the corrupt string in the first manifest using at least one of the identified plurality of repair strings.

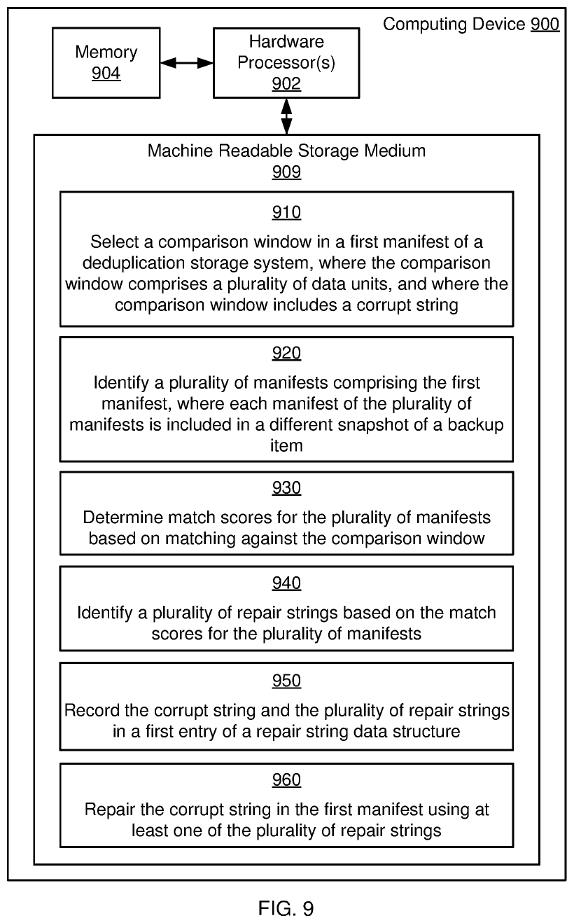

### FIG. 9—Example Computing Device

FIG. 9 shows a schematic diagram of an example computing device 900. In some examples, the computing device 900 may correspond generally to some or all of the storage system 100 (shown in FIG. 1). As shown, the computing device 900 may include a hardware processor 902, a memory 904, and machine-readable storage 905 including instructions 910-960. The machine-readable storage 905 may be a non-transitory medium. The instructions 910-960 may be executed by the hardware processor 902, or by a processing engine included in hardware processor 902. The instructions 910-950 may correspond generally to the examples described above with reference to blocks 710-750 (shown in FIG. 7)

Instruction 910 may be executed to select a comparison window in a first manifest of a deduplication storage system, where the comparison window comprises a plurality of data units, and where the comparison window includes a corrupt string. Instruction 920 may be executed to identify a plurality of manifests comprising the first manifest, where each manifest of the plurality of manifests is included in a different snapshot of a backup item.

Instruction 930 may be executed to determine match scores for the plurality of manifests based on matching against the comparison window. Instruction 940 may be executed to identify a plurality of repair strings based on the match scores for the plurality of manifests. Instruction 950 may be executed to record the corrupt string and the plurality of repair strings in a first entry of a repair string data structure. Instruction 960 may be executed to repair the corrupt string in the first manifest using at least one of the identified plurality of repair strings.

In accordance with some implementations of the present disclosure, a controller of a deduplication storage system may repair snapshots that include corrupt strings. The controller may identify a corrupt string included in a snapshot of a source item. The controller may identify a first manifest that references the portion of the snapshot that includes the corrupt string. The controller may then select a comparison window from the first manifest, and may compare the comparison window to a set of candidate manifests associated with previous snapshots of the source item. The controller may assign a match score to each candidate manifest based on its similarity to the comparison window. Further, the controller may identify a set of repair strings based on the match scores, and may record the corrupt string and the set of repair strings in an entry of a stored data structure. Subsequently, the controller may compare a received input string against the stored data structure, and may thereby determine whether the input string matches a corrupt string recorded in an entry of the stored data structure. If so, the controller may read the entry to identify a repair string for that corrupt string. The controller may use the repair string to perform an attempted repair, and may determine whether the attempted repair is valid (e.g., based on input by a human user or an automated test process). If it is determined that the first attempted repair is not valid, the controller may reverse the first attempted repair using a stored repair history data structure, read the entry to identify a second repair string, and use the second repair string to perform another attempted repair. In this manner, multiple repairs may be attempted until reaching a determination that a repair is valid, or a determination that no more repair strings are available. Accordingly, some implementations may reduce the amount of corrupt data stored in the storage system. Further, some implementations may reduce the loss of data and the performance impact associated with recovery from each instance of the corrupt string.

Note that, while FIGS. 1-9 show various examples, implementations are not limited in this regard. For example, referring to FIG. 1, it is contemplated that the storage system 100 may include additional devices and/or components, fewer components, different components, different arrangements, and so forth. In another example, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
a processor;
a memory; and
a machine-readable storage storing instructions, the instructions executable by the processor to:
select a comparison window in a first manifest of a deduplication storage system, wherein the comparison window comprises a plurality of data units, and wherein the comparison window includes a corrupt string;
identify a plurality of manifests comprising the first manifest, wherein each manifest of the plurality of manifests is included in a different snapshot of a backup item;
determine match scores for the plurality of manifests based on matching against the comparison window;
identify a plurality of repair strings based on the match scores for the plurality of manifests;
record the corrupt string and the plurality of repair strings in a first entry of a repair string data structure; and
repair the corrupt string in the first manifest using at least one of the plurality of repair strings.

2. The computing device of claim 1, including instructions executable by the processor to, subsequent to repairing the corrupt string in the first manifest:
receive a new data string to be stored in the deduplication storage system; and
in response to a determination that the new data string matches the corrupt string recorded in the first entry of the repair string data structure, repair the new data string using one or more of the plurality of repair strings recorded in the first entry of the repair string data structure.

3. The computing device of claim 2, including instructions executable by the processor to:
select, from the plurality of repair strings recorded in the first entry, a first repair string having a highest rank;
perform a first attempted repair of the new data string using the first repair string; and
record information regarding the first attempted repair in a repair history data structure.

4. The computing device of claim 3, including instructions executable by the processor to:
determine whether the first attempted repair is valid;
in response to a determination that the first attempted repair is not valid:
obtain the information regarding the first attempted repair from the repair history data structure; and
reverse the first attempted repair using the obtained information regarding the first attempted repair.

5. The computing device of claim 4, including instructions executable by the processor to, in response to the determination that the first attempted repair is not valid:
select, from the plurality of repair strings recorded in the first entry, a second repair string having a second-highest rank; and
perform a second attempted repair of the new data string using the second repair string.

6. The computing device of claim 3, wherein the information regarding the first attempted repair comprises:
a location of the first attempted repair;
the corrupt string repaired in the first attempted repair;
the first repair string used in the first attempted repair; and
a time stamp of the first attempted repair.

7. The computing device of claim 2, including instructions executable by the processor to:
compare the new data string to a plurality of entries in the repair string data structure;
determine that the new data string includes a first set of data units and a second set of data units, wherein the first set of data units matches the corrupt string recorded in the first entry of the repair string data structure, and wherein the second set of data units includes a count of data units that are not included in the corrupt string recorded in the first entry; and
in response to a determination that the count of data units in the second set does not exceed a maximum threshold of additional data units, determine that the new data string matches the corrupt string recorded in the first entry of the repair string data structure.

8. The computing device of claim 1, wherein each of the plurality of repair strings is identified in a different manifest of the plurality of manifests.

9. A method comprising:
selecting, by a storage controller, a comparison window in a first manifest of a deduplication storage system, wherein the comparison window comprises a plurality of data units, and wherein the comparison window includes a corrupt string;
identifying, by the storage controller, a plurality of manifests comprising the first manifest, wherein each manifest of the plurality of manifests is included in a different snapshot of a backup item;
determining, by the storage controller, match scores for the plurality of manifests based on matching against the comparison window;
identifying, by the storage controller, a plurality of repair strings based on the match scores for the plurality of manifests;
recording, by the storage controller, the corrupt string and the plurality of repair strings in a first entry of a repair string data structure; and
repairing, by the storage controller, the corrupt string in the first manifest using at least one of the plurality of repair strings.

10. The method of claim 9, comprising, after repairing the corrupt string in the first manifest:
receiving a new data string to be stored in the deduplication storage system;
determining whether the new data string matches the corrupt string recorded in the first entry of the repair string data structure; and
in response to a determination that the new data string matches the corrupt string recorded in the first entry of the repair string data structure, repairing the new data string using one or more of the plurality of repair strings recorded in the first entry of the repair string data structure.

11. The method of claim 10, comprising:
selecting, from the plurality of repair strings recorded in the first entry, a first repair string having a highest rank;
performing a first attempted repair of the new data string using the first repair string; and
recording information regarding the first attempted repair in a repair history data structure.

12. The method of claim 11, comprising:
determining whether the first attempted repair is valid;
in response to a determination that the first attempted repair is not valid:
obtaining the information regarding the first attempted repair from the repair history data structure;
reversing the first attempted repair using the obtained information regarding the first attempted repair.

13. The method of claim 12, comprising, in response to the determination that the first attempted repair is not valid:
selecting, from the plurality of repair strings recorded in the first entry, a second repair string having a second-highest rank; and
performing a second attempted repair of the new data string using the second repair string.

14. The method of claim 10, comprising:
comparing the new data string to a plurality of entries in the repair string data structure;
determining that the new data string includes a first set of data units and a second set of data units, wherein the first set of data units matches the corrupt string recorded in the first entry of the repair string data structure, and wherein the second set of data units includes a count of data units that are not included in the corrupt string recorded in the first entry; and
in response to a determination that the count of data units in the second set does not exceed a maximum threshold of additional data units, determining that the new data string matches the corrupt string recorded in the first entry of the repair string data structure.

15. A non-transitory machine-readable medium storing instructions that upon execution cause a processor to:
select a comparison window in a first manifest of a deduplication storage system, wherein the comparison window comprises a plurality of data units, and wherein the comparison window includes a corrupt string;
identify a plurality of manifests comprising the first manifest, wherein each manifest of the plurality of manifests is included in a different snapshot of a backup item;
determine match scores for the plurality of manifests based on matching against the comparison window;
identify a plurality of repair strings based on the match scores for the plurality of manifests;
record the corrupt string and the plurality of repair strings in a first entry of a repair string data structure; and
repair the corrupt string in the first manifest using at least one of the plurality of repair strings.

16. The non-transitory machine-readable medium of claim 15, including instructions that upon execution cause the processor to, subsequent to repairing the corrupt string in the first manifest:
receive a new data string to be stored in the deduplication storage system; and
in response to a determination that the new data string matches the corrupt string recorded in the first entry of the repair string data structure, repair the new data string using one or more of the plurality of repair strings recorded in the first entry of the repair string data structure.

17. The non-transitory machine-readable medium of claim 16, including instructions that upon execution cause the processor to:
select, from the plurality of repair strings recorded in the first entry, a first repair string having a highest rank;
perform a first attempted repair of the new data string using the first repair string; and
record information regarding the first attempted repair in a repair history data structure.

18. The non-transitory machine-readable medium of claim 17, including instructions that upon execution cause the processor to:
determine whether the first attempted repair is valid;
in response to a determination that the first attempted repair is not valid:
obtain the information regarding the first attempted repair from the repair history data structure;
reverse the first attempted repair using the obtained information regarding the first attempted repair.

19. The non-transitory machine-readable medium of claim 18, including instructions that upon execution cause the processor to, in response to the determination that the first attempted repair is not valid:
select, from the plurality of repair strings recorded in the first entry, a second repair string having a second-highest rank; and
perform a second attempted repair of the new data string using the second repair string.

20. The non-transitory machine-readable medium of claim 16, including instructions that upon execution cause the processor to:
compare the new data string to a plurality of entries in the repair string data structure;
determine that the new data string includes a first set of data units and a second set of data units, wherein the first set of data units matches the corrupt string recorded in the first entry of the repair string data structure, and wherein the second set of data units includes a count of data units that are not included in the corrupt string recorded in the first entry; and
in response to a determination that the count of data units in the second set does not exceed a maximum threshold of additional data units, determine that the new data string matches the corrupt string recorded in the first entry of the repair string data structure.
